(19) United States
(12) Patent Application Publication
(10) Pub. No.: US 2008/0033758 A1
(43) Pub. Date: Feb. 7, 2008

(54) Evidence-based outcomes system

(76) Inventor: Damon A.J. Keeley, Union, NJ (US)

Correspondence Address: DAY PITNEY LLP, 7 TIMES SQUARE, NEW YORK, NY, 10036-7311, US

(21) Appl. No.: 11/973,080

(22) Filed: Oct. 5, 2007

Related U.S. Application Data
(63) Continuation of application No. 10/227,686, filed on Aug. 26, 2002.
(60) Provisional application No. 60/314,596, filed on Aug. 24, 2001.

(51) Int. Cl. G06Q 50/00

(52) U.S. Cl. 705/2

(57) ABSTRACT

The evidence-based outcomes system is a multifunction web-based process to optimize performance of industry-specific programs. The system is applicable to virtually all industries which require optimized performance. However, the system is particularly applicable to the health care industry, which, of course, requires optimized performance. The system is further particularly applicable to bloodless medicine and surgery versus homologous medicine and surgery, which is an application with performance which is particularly sensitive to changes in input to the system. The system is typically implemented with an industry team of experts, a program team which collects and enters relevant data, a technology team which manages the relational database and a business team which uses evidence-based analysis of outcomes to develop and recommend policies that will enhance program financial performance.

This patent application is a continuation of application Ser. No. 10/227,686 filed on Aug. 26, 2002, which claims priority of provisional application Ser. No. 60/314,596 entitled “Evidence Based Outcomes Management System”, filed on Aug. 24, 2001, the contents of which are hereby incorporated by reference.

### BACKGROUND OF THE INVENTION

1. Field of the Invention

The present invention, an evidence-based outcomes system, is a multifunction web-based process to optimize performance of industry-specific programs. The invention is applicable to virtually all industries which require optimized performance. However, the invention is particularly applicable to the health care industry, which, of course, requires optimized performance. The invention is further particularly applicable to bloodless medicine and surgery, which is an application with performance which is particularly sensitive to changes in input to the system.

2. Description of the Prior Art

Many participants in various industries require rapid access to a large database of industry-specific information about standards, costs, and outcomes within the context of the industry in which they are participating. This information can be used to respond to industry generated questions regarding some or all of the following: (i) industry standards; (ii) regimens or method for reducing risk and increasing adherence to standard operating procedures; (iii) the costs associated with meeting industry standards; and (iv) degree of customer satisfaction. These requirements extend to all industries in which optimized performance is required. However, these requirements are particularly relevant to the health care industries as a whole, and to the bloodless medicine and surgery field, among others.

Bloodless medicine and surgery involves comprehensive blood conservation programs that eliminate the need for medical and surgical patients to receive homologous (donor) blood transfusions. This is achieved through the use of various clinical protocols, technologies, drugs and blood components.

The key to success of a bloodless medicine and surgery program is the comprehensive clinical coordination of patient care. This includes care for medical patients as well as surgical patients. In some hospitals, simply changing operative and anesthesiology protocols has reduced overall blood use by as much as thirty percent. By establishing policies and procedures and clinical coordination of therapies, pharmacology, technology and expertise, blood use can be cut by more than half in an average hospital, representing millions of dollars in annual savings. Some bloodless medicine and surgery programs, by applying such procedures in a coordinated manner with dedicated and trained staff and with training for physicians have reported 66-88% reductions in donor blood transfusions. Data has shown that bloodless medicine and surgery is also less expensive medicine clinically. Due to set reimbursements for different types of cases and reduced insurance payments, the ability to reduce clinical costs is often imperative to a hospital's financial viability.

To date, no systems have provided the above identified information in a rapid, organized and satisfactory way.

### OBJECTS AND SUMMARY OF THE INVENTION

It is therefore an object of the present invention to provide rapid access to a large database of industry-specific information.

It is therefore a further object of the present invention to provide a method and apparatus which optimizes the output of a system.

It is therefore a still further object of the present invention to achieve the above objects in a wide variety of industries.

It is therefore a still further object of the present invention to achieve the above objects particularly in the medical field.

It is therefore a still further object of the present invention to achieve the above objects specifically in the bloodless medicine and surgery field.

These and other objects are attained by a computerized system which efficiently collects input data, transmits the data to a centralized storage facility in order to aggregate, analyze and compare the data against industry standards and best practices, and create performance reports for the particular industry.

In a medical application in general, and in bloodless medicine and surgery in particular, the method and apparatus of the present invention collects and analyzes statistical information about the medical application. The data is then compared to industry benchmarks and best practices. Feedback is provided to the medical establishment, such as a hospital. The invention further continuously improves the entire process by incorporating newly learned measurement parameters and methodologies.

Typically, the following teams of people are used to implement this system:

1. An industry team which is typically comprised of physicians, registered nurses, and board certified specialists (such as perfusionists, if the specific application is bloodless medicine and surgery). Moreover, the application may require that a board of medical affairs, or similar organization, be represented on the industry team, for medical applications. Other industries may have analogous members of the industry team, such as engineers, scientists, metallurgists, materials scientists, accountants, computer programmers, systems administrators, etc. The industry team provides the expertise, identifies the best practices, develops the measurement parameters, and provides the industry benchmark data to measure individual performance of the hospital or other institution, such as a factory, appropriate to the application.

2. A program team which typically collects and enters all relevant data (in medical applications, this is typically patient data, in other applications, this may be data about the raw materials or finished products) to calculate the program's outcomes and effectiveness. The program team sets the training and educational goals of the program.

3. A technology team which manages the web-based relational database system. The technology team uses historic benchmarks and key performance indicators to generate timely and accurate reports.

4. A business team which uses evidence-based analysis of outcomes to develop and recommend policies that will enhance program financial performance. The business team sets the financial goals of the program, provides real time management and manages the entire process.

In a medical application, the system will be used to:

1. Improve patient care.

2. Effect continual improvement of procedures.

3. Increase client hospital or medical establishment revenues.

4. Provide feedback and recommend personnel training.

In a typical embodiment in the bloodless medicine and surgery field, the present invention provides a method for acquisition, management and processing of clinical procedure information and patient outcome information received from a group of participating physicians and hospitals to provide performance information. The system provides an integrated set of processes including a comprehensive set of assessment algorithms. These algorithms enable past results to be monitored and interpreted so as to improve future outcomes.

The system includes a data input process for receiving data including a physician component having clinical procedure information and a patient component having the patient outcome information to provide clinical procedure-outcome data; database processing which translates the protocol-outcome data to a predetermined format and stored the clinical procedure-outcome data having the predetermined format in a database; and a data analysis process. The data analysis process includes a) selectively receiving outcome data from the database, b) analyzing the received clinical procedure-outcome data, and c) summarizing the procedure-outcome data to provide performance results. The system and method further include a data correlating process which correlates the performance results associated with at least one physician with portions of the stored clinical procedure-outcome data to provide a physician measure and a report generation process to provide a report from the performance results and the physician measure.

In a particularly exemplary embodiment, the invention integrates bloodless medicine and surgery principles into treatment programs. Bloodless medicine and surgery is a comprehensive approach to patient care without the use of donor (homologous) blood or donor blood products. Through the combination of blood conservation protocols, medical devices and drugs, bloodless medicine and surgery programs can eliminate or significantly reduce the need for blood transfusions for medical and surgical patients.

According to the present invention, all of the elements of a bloodless medicine and surgery program are integrated, including customized planning, treatment and follow-up, thereby facilitating program management, improving efficiency and reducing costs. The integrated service provided by the invention reduces time, direct costs, and indirect costs often incurred through information and communication gaps, excessive paperwork and inappropriate utilization, thereby enhancing the ability of the system to provide quality health care through case management and participant physician interaction via smart systems.

Another feature of the invention includes the provision of customized recommendations for outcome enhancing protocols and for the periodic monitoring of participant physician performance so as to identify and address problems and provide corrective measures. Both concurrent and retrospective utilization reviews are contemplated to continually update recommended protocols.

In accordance with yet another feature of the invention, provision is made for educational programs which are linked to the system and available to participants.

Analogous results will be achieved for non-medical applications using the present invention.

### BRIEF DESCRIPTION OF THE DRAWINGS

Further objects and advantages of the invention will become apparent from the following description and claims, and from the accompanying drawings, wherein:

FIG. 1 is a schematic of the principal components of the system for a bloodless medicine and surgery application using the present invention.

FIG. 2 is a schematic representation of the database structural requirements for a bloodless medicine and surgery application using the present invention.

FIG. 3 is a flowchart of the data entry for a bloodless medicine and surgery application using the present invention.

FIG. 4 is an outline of a typical blood cost savings algorithm used in the present invention.

The figures are applicable by analogy to many medical, industrial and other applications.

### DETAILED DESCRIPTION OF THE PREFERRED EMBODIMENTS

The present invention implements a computerized system to qualify and quantify the benefits of any particularized input to optimize the output of a system. In particular, in the bloodless medicine and surgery field, the computerized system qualifies and quantified the benefits of bloodless medicine and surgery (BMS) to prove to existing and potential client hospitals that BMS improves patient outcomes and saves money for the hospital or other medical establishment. The system provides an efficient way to collect BMS patient data, transmit the data to a centralized storage facility, and then aggregate, analyze and compare the data against industry standards and best practices, and create relevant performance reports for the client hospitals. Of course, the present invention can be similarly implemented for other medical procedures.

The method and apparatus of the present invention collects and analyzes statistical information about the BMS or other medical (or other industrial) application. The data is compared to industry benchmarks and best practices. Feedback is provided to client hospitals, and the process is improved by incorporating newly learned measurement parameters and methodologies.

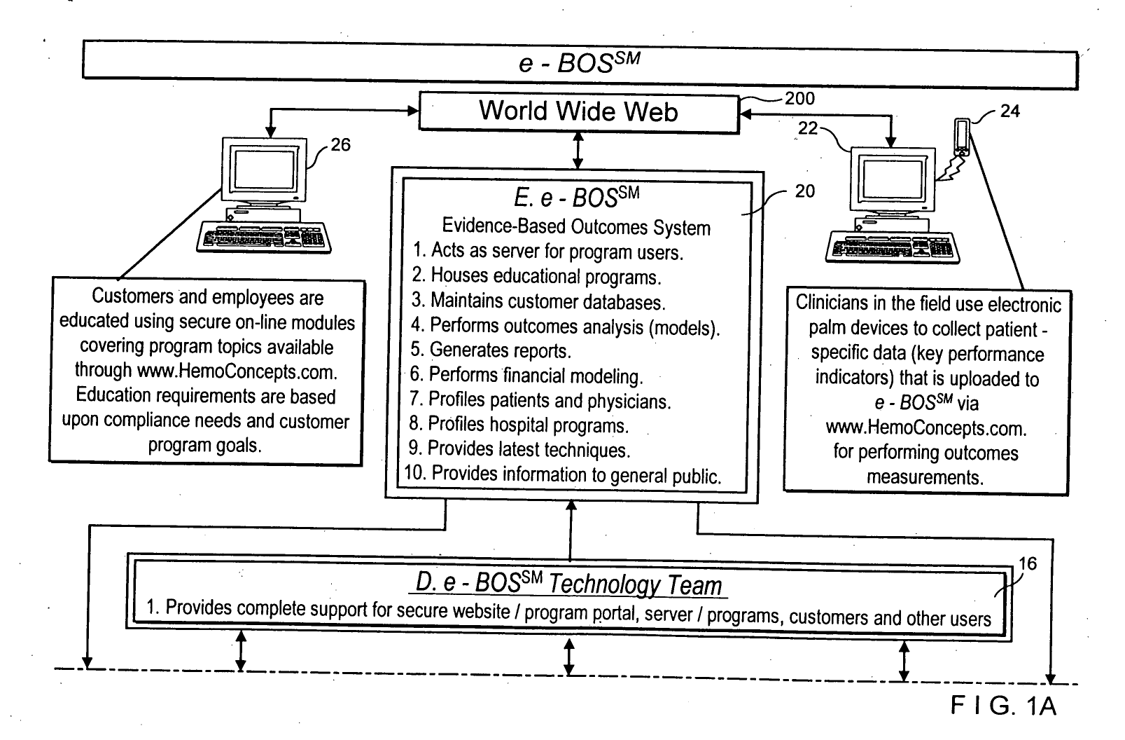

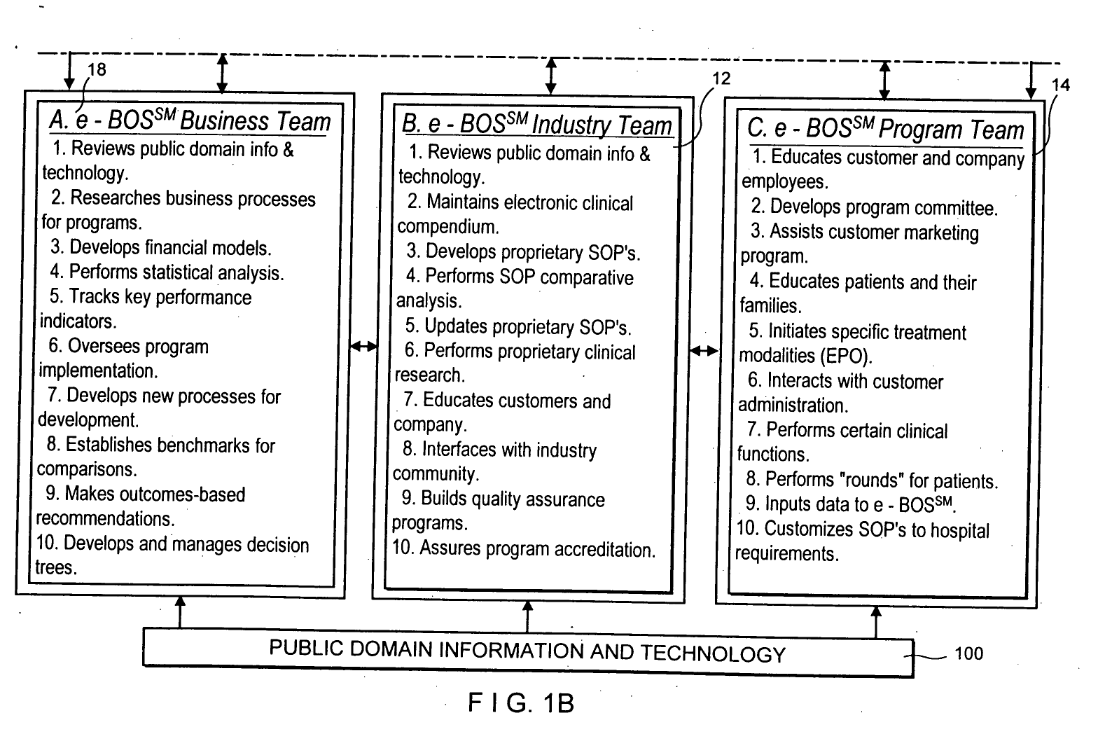

The following teams of people as shown in FIG. 1 are used in the implementation of the method and apparatus of the present invention.

1. An industry team (element 12, FIG. 1) which is typically comprised of physicians, registered nurses, and board certified specialists (such as perfusionists, if the specific application is bloodless medicine and surgery). Moreover, the application may require that a board of medical affairs, or similar organization, be represented on the industry team, for medical applications. Other industries may have analogous members of the industry team, such as engineers, scientists, metallurgists, materials scientists, accountants, computer programmers, systems administrators, etc. The industry team provides the expertise, identifies the best practices, develops the measurement parameters, and provides the industry benchmark data to measure individual performance of the hospital or other institution, such as a factory, appropriate to the application. More particularly, the industry team reviews public domain information and technology; maintains an electronic clinical compendium; develops standard operating procedures; performs standard operating procedure comparative analysis; updates standard operating procedures; performs clinical research; educates the customers and the company; interfaces with the industrial community; builds quality assurance programs; and assures program accreditation. In summary, the industry team 12 of recognized experts provides the in-depth knowledge to develop an initial set of education modules, and standard operating procedures that will act as the basis for initial program implementation or take-over. Industry team 12 assists in various aspects of education, program implementation and executive decision making. Thereafter, industry team 12 maintains a vigilant watch for anything in the in the industry that could be added or eliminated from the program to add program value. Industry team 12 receives information from public domain information and technology 100 and exchanges information in both directions with the program team 14, the technology team 16 and the business team 18.

2. Program team 14 which typically collects and enters all relevant data (in medical applications, this is typically patient data, in other applications, this may be data about the raw materials or finished products) to calculate the program's outcomes and effectiveness. The program team 14 sets the training and educational goals of the program. More specifically, the program team 14 educates customer and company employees; develops a program committee; assists a customer marketing program; educates patients and their families; initiates specific treatment modalities; interacts with customer administration; performs clinical functions; performs “rounds” for patients; inputs data into the server 20 via technology team 16; and customizes the standard operating procedures to the requirements of the hospital or other client. In short, the program team develops a task-oriented plan to implement program standard operating procedures, to educate individuals involved in the program and to provide any tools necessary to achieve maximum program value. The program team 14 receives information from public domain information and technology 100 and exchanges information in both directions with the industry team 12 and the technology team 16, and receives information from the server 20.

3. Technology team 16 which manages the web-based relational database system. The technology team uses historic benchmarks and key performance indicators to generate timely and accurate reports. Further, the technology team 16 provides support for a secure website and inputs data into the server 20 as received in data exchanges from industry team 12, program team 14 and business team 18.

4. Business team 18 which uses evidence-based analysis of outcomes to develop and recommend policies that will enhance program financial performance. The business team 18 sets the financial goals of the program, provides real time management and manages the entire process. More specifically, the business team 18 reviews public domain information and technology; researches business processes for programs; develops financial models; performs statistical analysis; tracks key performance indicators; oversees program implementation; develops new processes for development; establishes benchmarks for comparisons; makes outcomes-based recommendation; and develops and manages decision trees. In advance of launching any program, business team 18 identifies key performance indicators that are programmed into server 20 so that outcomes-sensitive data can be collected after the program is initiated to produce reports detailing the programs evidence-based outcomes (in the case of bloodless medicine and surgery, these might include units of blood transfused, pre-donated units versus hemodiluted units, etc.). Furthermore, business team 18 performs financial analysis upon the program reports to illustrate areas of financial strength and weakness of the program. The software can perform comparative analyses based upon any number of program outcomes to monitor program value (in the case of bloodless medicine and surgery, this may include percentage of donor blood reduction per month or quarter in various hospitals; the number of pre-donated units versus number and reduction of post operative infections, etc.). The business team 18 receives information from public domain information and technology 100 and exchanges information in both directions with the industry team 12 and the technology team 16, and receives information from the server 20.

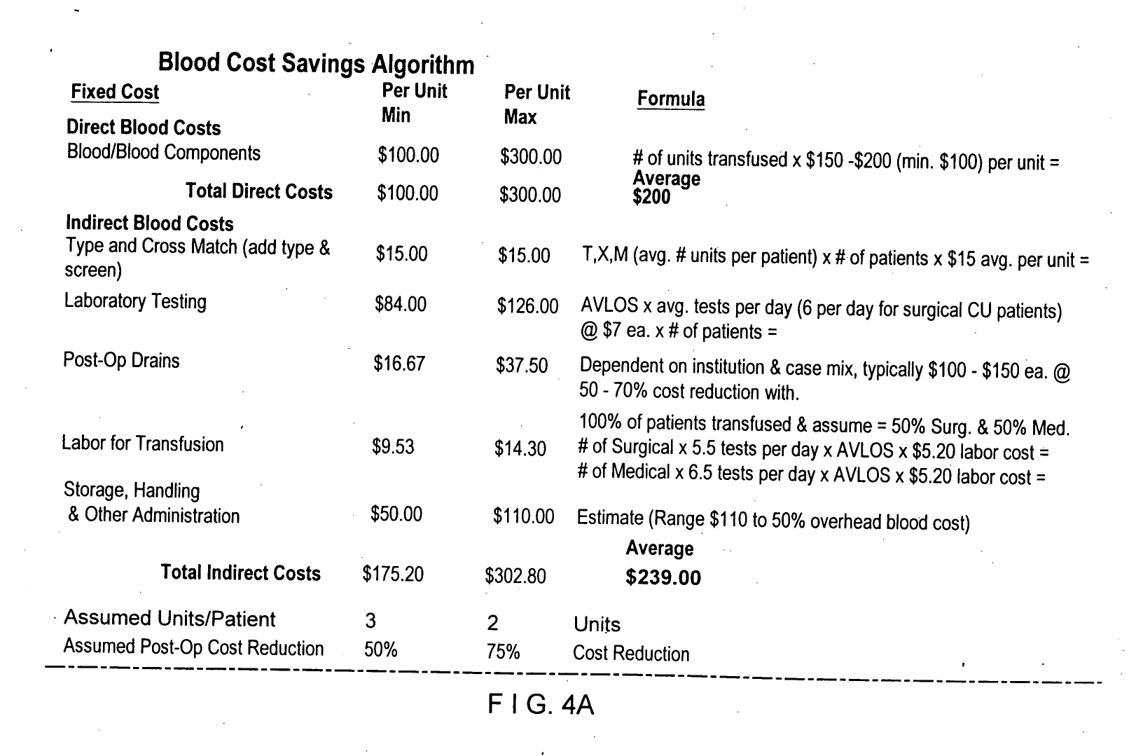

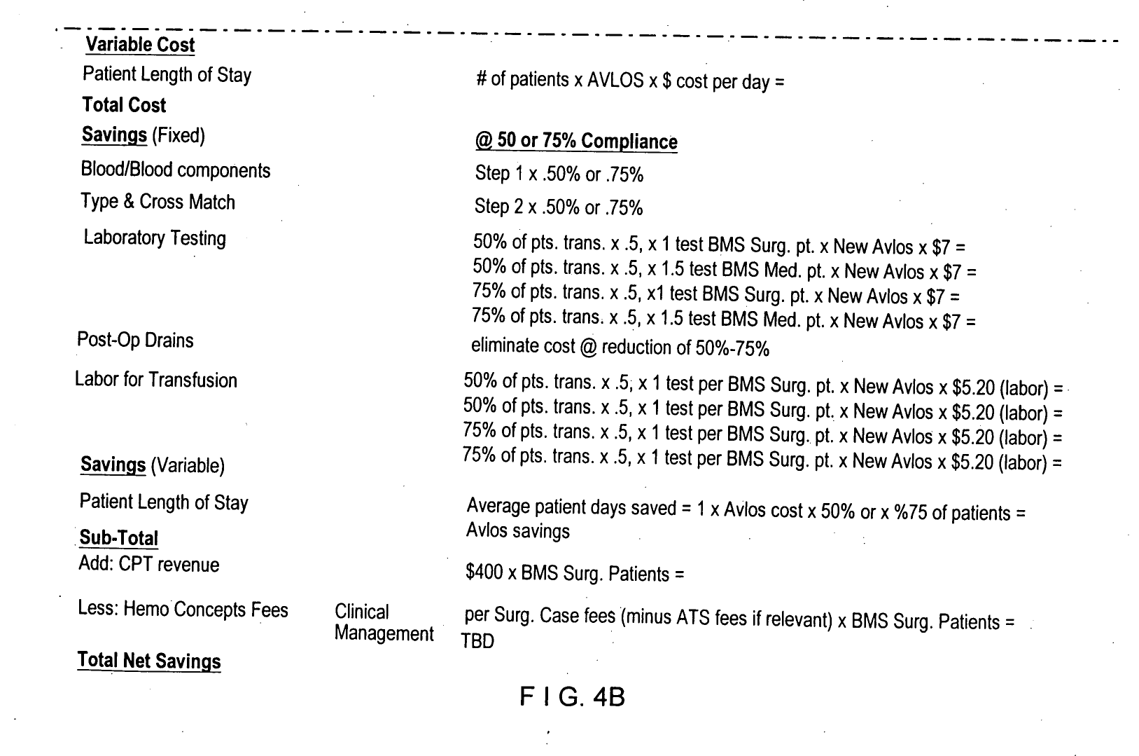

Operation of the system is envisioned to result in an “endless loop”, wherein the industry team maintains best practices, the program team 14 keeps knowledge current through continuous education and return on customer investment is kept very high through a healthy respect for the economic considerations of the business team 18 and as calculated by the algorithm outlined in FIG. 4.

The server 20 (which is envisioned to be a Microsoft SQL server, but other equivalent substitutions may be made) communicates with the world wide web. Furthermore, the server 20 receives information from technology team 16 which, as stated previously, is in two-way communication with industry team 12, program team 14 and business team 18. Similarly, server 20 transmits information to program team 14 and business team 18. Server 20 performs the evidence-based outcome algorithm by performing outcomes analysis. Server 20 further provides educational programs; maintains customer databases; generates reports; performs financial modeling; profiles patients and physicians; profiles hospital programs; provides latest techniques; and provides information to the general public.

Terminals 22, typically via electronic palm devices 24, if permitted in the hospital, are used by clinicians in the field to collect patient-specific data (key performance indicators) that is uploaded to server 20 via world wide web 200 for performing outcomes measurements. Similarly, terminals 26 can be used by customers or employees to access server 20 via world wide web 200 to receive educational programs using secure on-line modules covering program topics. Educational requirements are based upon the compliance needs and customer program goals.

All information is captured into a centralized relational database within server 20 to determine program improvements, drive compliance and achieve program goals. Typically, the process could be marketed on an annual subscription basis.

Data for the centralized relational database can be captured by a direct extraction link to the hospital (or other medical establishment or even other industry) computer systems, via manual data entry (such as by electronic palm devices 24).

The application and database are expected to be flexible and scaleable to accommodate a plurality of hospitals or other institutions. The application is envisioned to be platform independent utilizing web-based user interface screens, and accessible via Virtual Private Network (VPN) connections from the different client sites to the central database site.

Data can be loaded into a multi-dimensional database to provide flexible and powerful drill-down views of the data. The analysis and reporting of the data will show to clients (such as doctors, hospitals and patients in a medical application such as bloodless medicine and surgery) the benefits of using the chosen application (such as bloodless medicine and surgery).

Statistical and clinical data about each episode of hospital stay by the patient (in a medical application, with analogous information being kept in different applications), containing the information necessary to aggregate and benchmark the hospital's performance for the specific medical application (such as bloodless medicine and surgery) may be collected. In medical applications, it will be common for privacy concerns to arise. Therefore, in these situations, it would be common for no name or social security number to be collected. Patients would typically be identified by the medical record number and registration or billing number.

A periodic (such as monthly) aggregation of the patient statistical and clinical data is performed for each hospital or medical establishment. The aggregate data will be stored for benchmark reporting and historical analysis.

Industry benchmark information is collected by the industry team 12 and entered into the database for use in the creation of benchmark reports where individual hospital performance is compared against industry standards and best practices.

The periodic aggregation along with industry benchmark data is stored within the database to provide historical comparison reporting.

To provide for flexible reporting and analysis of the patient statistical and clinical data, the detail records can be loaded into a multi-dimensional data warehouse. The appropriate tools may be used to provide data analysis and drill-down views.

It is envisioned that the database would be scaleable to provide for expansion to multiple hospitals or other establishments. Additionally, it is envisioned that older data may be purged periodically.

It is envisioned that most, if not all, of the functions of server 20 will be accessible via a web browser and that this will be the main method of data entry. Patient data already extracted from hospital systems will need only to be updated, thereby minimizing data entry time. This web-based data entry provides flexibility in that data can be entered by a coordinator at the hospital site, from home via modem connection to the Internet or by data entry operators off-site from the hospital. It is further envisioned that data entered manually can be merged with data directly entered by a link with the hospital.

Moreover, client hospital personnel will be able to connect via terminals 26 using a virtual private network to server 20 to perform queries and generate reports.

Electronic palm devices 24 may be used by coordinators and nurses to collect initial patient information as well as subsequent clinical information. Active patients' information will be downloaded to the palm devices 24 so that only missing data needs to be entered.

Typically, the computer of the coordinator will have a palm synchronization application that will act as a conduit to transfer data back and forth between the central database of server 20 and the electronic palm device 24.

Periodic (such as monthly) aggregation or summarization of the patient statistical and clinical data is performed for each hospital. The aggregate data is stored for benchmark reporting and historical analysis.

Standard and often-used queries will be compiled and will be available, along with responses, via server 20 for access by the client. Moreover, the flexibility and power of the relational database is envisioned to allow for querying of the data stored in many different and ad hoc ways. The database is designed to provide meaningful data element names to facilitate and encourage ad hoc querying.

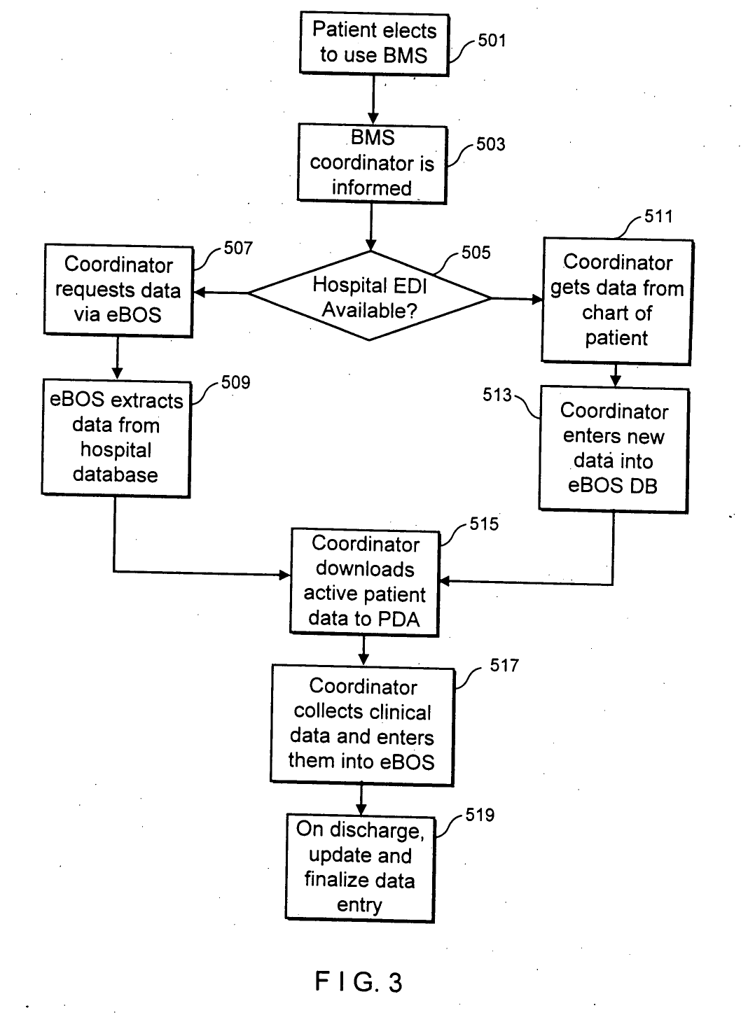

FIG. 3 shows a typical data entry flowchart for bloodless medicine and surgery, but is applicable to other medical and industrial applications.

The data collection starts when a patient is admitted to the hospital and elects to use bloodless medicine and surgery as shown in block 501. The patient is either a “walk-in” or is recommended or referred by a BMS practitioner. The hospital staff explains the benefits of BMS to a walk-in patient. The BMS coordinator is informed that a new patient has elected BMS as shown in block 503. The BMS coordinator interviews the patient, ensures that BMS information is recorded in the patient's chart and that BMS protocols and requirements are met.

If there is electronic data interchange (EDI) from the hospital database (see block 505), then hospital personnel enter BMS data along with other patient data into the hospital database and the BMS coordinator records the patients medical record and registration numbers. At the end of the day or at some other specified time, the BMS coordinator enters the request for data extraction via server 20 (see block 507). The server 20 then automatically connects to the hospital computer system and extracts the patient's information (see block 509) and this information is added into the database.

If there is no electronic data interchange (EDI) from the hospital database, then the BMS coordinator gets BMS data from the patient's chart or from a patient interview (see block 511). At the end of the day or at some other specified time, the BMS coordinator enters all patient data into the database of server 20 (see block 513).

In any event, during the patient's stay at the hospital, clinical information is collected and entered into the patient record in the database of server 20. Updates may be entered via web-based data entry screens or electronic palm devices (see blocks 515, 517). Upon patient discharge, the BMS coordinator finalizes the update on the electronic palm device (see block 519). The final upload unlocks the patient record on the central database for general updating.

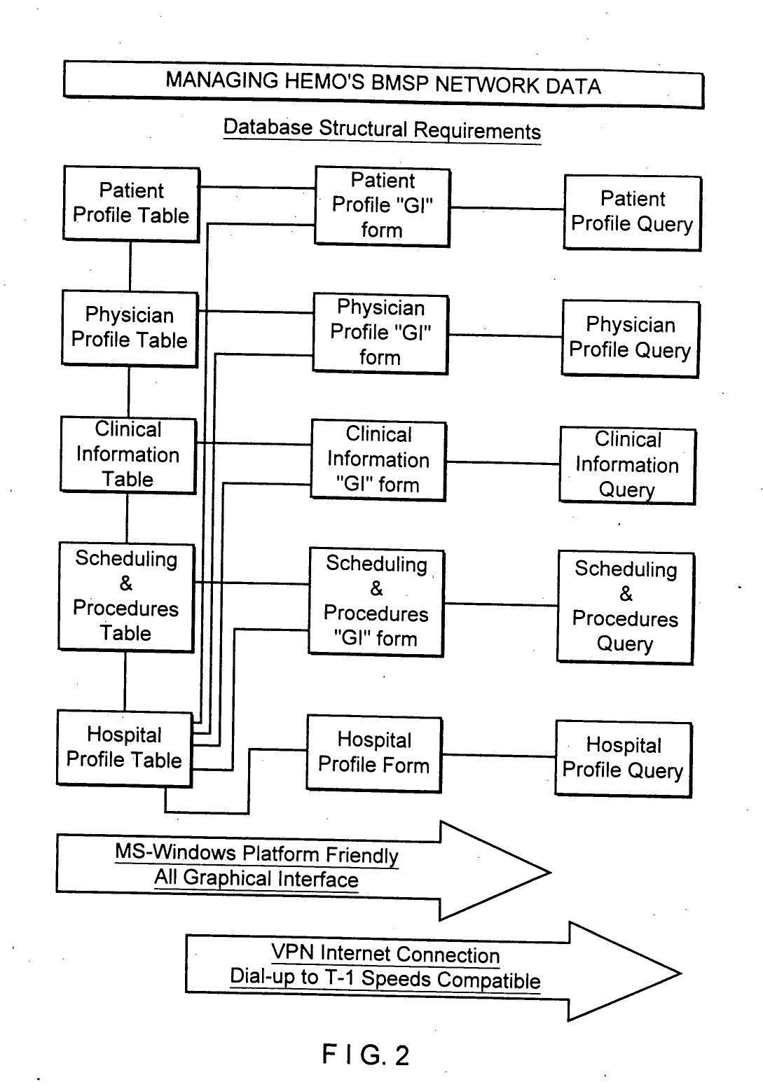

FIG. 2 illustrates the database structural requirements in achieving the above processes. An exemplary system includes parameters dealing with bloodless medicine and surgery program protocols and participant files which are indicative of those data which affect operation and implementation of a bloodless medicine and surgery program or any other industry specific program for which evidence based outcomes management is desired. These parameters may include but are not limited to patient data, physician data, clinical data, management data and scheduling data.

Still another feature of the invention is the optional integration of ancillary services into the system. Ancillary services are the totality of supporting services, including educational services, that are needed to support a bloodless medicine and surgery program or any other specific industry program for which outcomes management is desired.

A participant file is provided to represent several classes of information and data that re useful in practicing the principles of the invention. While some of these data and information may be included elsewhere in the system so long as they are generally accessible therein, it may be convenient to describe them as if included within the participant file. Accordingly, such data and information should be understood to contemplate the physical location of such data in other sites as well as, or in addition to files in the participant's location.

In accordance with one aspect of the invention, software analyzes the data to assess the patient outcome and identify corresponding treatment providers. The system prepares a report corresponding to the outcome data together with recommendations to be implemented. It also contemplates the identification within the participant file of those outcomes for which peer review and/or physician education are deemed necessary or desirable. These reports are then communicated to the participant. This may be accomplished in many convenient ways such as printout, orally or by e-mail.

According to a feature of the system, review may be tailored to meet established criteria. Thus, selected levels of expense, types of procedures, length of expected hospitalization, or other criteria may be utilized to identify those items for which further review and/or education is indicated.

The system may be tailored to consider any of a variety of factors for review such as cost, treatment results, referral matters and the like. From a review of the cost effectiveness of an item under consideration factors indicative of quality control may be readily calculated by the system using desired criteria. Moreover, from study of system data, recommendations and reports are generated to form the basis for future improvements.

Thus the several aforementioned objects and advantages are most effectively attained. Although preferred embodiments of the invention have been disclosed and described in detail herein, it should be understood that this invention is in no sense limited thereby and its scope is to be determined by that of the appended claim.

What is claimed is:

1. A method of optimizing performance in a system comprising:
providing a computer apparatus which acts as a server, performs educational programs related to the system, maintains a customer database, performs outcomes analysis, and performs financial modeling;
providing a first team which provides technical expertise as to the operation of the system;
providing a second team which collects and enters data regarding the input and output of the system, said second team receiving data from said computer apparatus;
providing a third team which sets the financial goals of the system and measures the financial performance of the system, said third team receiving data from said computer apparatus;
providing a fourth team for maintaining and providing data to a computer system, wherein said first second and third teams are in two-way communication with said fourth team; and
providing said computer apparatus with access to a plurality of devices for receiving indicators as to performance of the system, wherein said indicators are used in outcomes analysis calculation.

2. A method of optimizing performance of a medical procedure comprising:
providing a computer apparatus which acts as a server, performs educational programs related to the system, maintains a customer database, performs outcomes analysis, and performs financial modeling;
providing a first team which provides technical expertise as to the medical procedure;
providing a second team which collects and enters data regarding occurrences and outcomes of the medical procedure, said second team receiving data from said computer apparatus;
providing a third team which sets the financial goals of the medical procedure and measures the financial performance of the medical procedure, said third team receiving data from said computer apparatus;
providing a fourth team for maintaining and providing data to a computer system, wherein said first second and third teams are in two-way communication with said fourth team; and
providing said computer apparatus with access to a plurality of devices for receiving information about patients receiving the medical procedure, wherein said information is used in outcomes analysis calculation.

3. A method of optimizing performance of a method for reducing homologous blood transfusions in medical procedures comprising:
providing a computer apparatus which acts as a server, performs educational programs related to the system, maintains a customer database, performs outcomes analysis, and performs financial modeling;
providing a first team which provides technical expertise as to reducing homologous blood transfusions in medical procedures;
providing a second team which collects and enters data regarding occurrences and outcomes of the method for reducing homologous blood transfusions in medical procedures, said second team receiving data from said computer apparatus;
providing a third team which sets the financial goals of the method for reducing homologous blood transfusions in medical procedures and measures the financial performance of the method for reducing homologous blood transfusions in medical procedures, said third team receiving data from said computer apparatus;
providing a fourth team for maintaining and providing data to a computer system, wherein said first second and third teams are in two-way communication with said fourth team; and
providing said computer apparatus with access to a plurality of devices for receiving information about patients receiving method for reducing homologous blood transfusion in the medical procedures, wherein said information is used in outcomes analysis calculation.

4. The method of claim 3 further including the step of said server maintaining a database which can be queried by a plurality of computer terminals.

5. The method of claim 4 further including the step of said database responding to predetermined queries and to ad hoc queries.

6. The method of claim 5 wherein said database is a relational database.

7. The method of claim 6 wherein said plurality of computer terminals communicate with said database via the internet.

8. The method of claim 7 wherein patients are not identified by name or social security number within said database.

9. The method of claim 8 further including the step of said server preparing reports as to the economic benefits of bloodless medicine and surgery.

10. The method of claim 9 wherein said reports compare costs of bloodless medicine and surgery versus medicine and surgery using homologous blood donation.
